(19) United States
(12) Patent Application Publication
(10) Pub. No.: US 2014/0213366 A1
(43) Pub. Date: Jul. 31, 2014

(54) METHOD TO CREATE A GAME LIKE COMPETITION BETWEEN TWO OR MORE SHOPPERS USING MOBILE SELF CHECKOUT SOFTWARE

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/756,172

(22) Filed: Jan. 31, 2013

(51) Int. Cl. A63F 13/12

(52) U.S. Cl. CPC A63F 13/12
USPC 463/40

(57) ABSTRACT

Techniques for allowing customers to participate in a competition while shopping are disclosed. The techniques include electronically joining a first mobile electronic device into a shopping competition among customers at a brick and mortar store. The techniques also include receiving a UPC code from a first physical item at a brick and mortar store into the first mobile electronic device, creating an electronic shopping cart which includes the first item on the first mobile electronic device, assigning a point value to the first mobile electronic device for selecting the first item for purchase, and selecting a winner among competition participants based on points earned by the competition participants in selecting items for purchase.

### BACKGROUND INFORMATION

1. Field of the Disclosure

The present invention relates to shopping at a retail location. In particular, examples of the present invention relate to an approach for allowing two or more customers with electronic devices at a brick and mortar store to compete with each other while adding items to a virtual shopping cart for purchase.

2. Background

Many consumers visit supermarkets and stores with other people while shopping. It is not uncommon for a group of friends or a family to go shopping together. These persons may move throughout a store to find the desired items. In some cases, these people may attempt to split up a shopping list and work individually to find the desired items more quickly. In some cases, people in the group may not be excited about shopping or may otherwise need some encouragement or desire additional enjoyment while shopping.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating a mobile electronic device used in accordance with some aspects of the present disclosure;

FIG. 2 is a schematic illustrating a mobile electronic device and a POS system used in accordance with some aspects of the present disclosure;

FIG. 3 is a schematic illustrating a POS system used in accordance with some aspects of the present disclosure;

FIG. 4 is a schematic illustrating a POS system used in accordance with some aspects of the present disclosure;

FIG. 5 is a schematic illustrating communications between a mobile electronic device and a server;

FIG. 6 is a drawing of a mobile electronic device with software thereon according to aspects of the present disclosure;

FIG. 7 is a drawing of a mobile electronic device with software thereon according to aspects of the present disclosure;

FIG. 8 is a drawing of a mobile electronic device with software thereon according to aspects of the present disclosure;

FIG. 9 is a drawing of a mobile electronic device with software thereon according to aspects of the present disclosure;

FIG. 10 is a schematic illustrating communications between a mobile electronic device and a POS system;

FIG. 11 is a schematic illustrating example components of a mobile electronic device;

FIG. 12 is a schematic illustrating example components of a server; and

FIG. 13 is a flow chart illustrating an exemplary customer shopping according to aspects of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The disclosure particularly describes how two or more customers with mobile electronic devices may shop at a brick and mortar store. The customers may shop in a competitive manner, individually collecting items and gaining points for each item in a game like competition to acquire the most points. Each customer may view the results of the competition while the competition is ongoing or after the completion of the competition. In some situations, two or more associated customers (i.e. friends or family shopping together) may pair their mobile devices together and then shop in a collaborative manner, individually collecting items from a shopping list for purchase while contributing these items to a common electronic shopping cart. The customers may acquire points for the items which they have collected and the competition results may be displayed on the mobile electronic device of each customer and each customer may provide interaction with other customers via the devices.

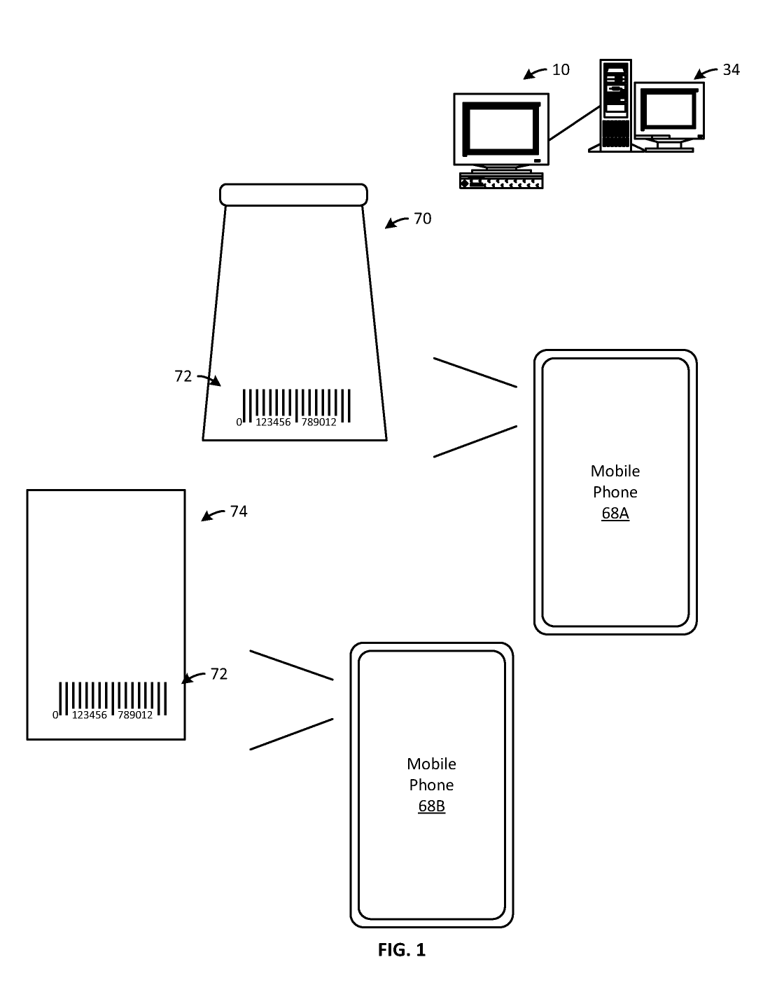

Referring to FIG. 1, a customer or group of customers may shop in a brick and mortar store. The brick and mortar store may include a point of sale (POS) system 10 including cash registers or terminals, etc. and may also include a server 34. The store may also stock various physical items for purchase. The customers may utilize mobile electronic devices 68A, 68B, such as smart phones or tablet computers, while shopping. The mobile electronic devices 68A, 68B may be used to “scan” items as items are selected for purchase, creating an electronic shopping cart. Scanning items refers to capturing item information into a mobile electronic device and may be accomplished by capturing a machine readable code such as a product barcode (commonly referred to herein as a UPC code) from products with a camera feature on the mobile electronic device. Customers may compete with other customers while shopping, earning points for the items which they have selected for purchase and added to an electronic shopping cart. Customers may work together to create a single common electronic shopping cart which is shared between the mobile electronic devices 68A, 68B and may gain points individually for items which they have selected, completing with each other as they shop.

The server 34 may facilitate communications between customers and may facilitate the competition between customers. The various mobile electronic devices 68A, 68B may communicate with the server 34 when an item is selected for purchase and item information is acquired into the mobile electronic device, such as by capturing a product UPC code with a device camera. The server may assign point values to the selected item, calculate a point total for the customer, transmit point information to customers who are involved in the competition, transmit item information to customers involved in the competition, etc.

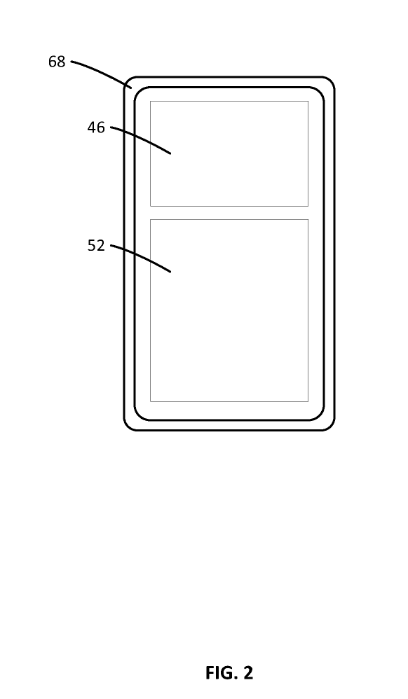

The customers may have mobile electronic devices 68A, 68B which have mobile self-checkout software loaded thereon. Each customer may use a mobile electronic device 68 while shopping to create an electronic list or electronic shopping cart of items which the customer selects for purchase at the store and to display information regarding a competition in which the customer is participating. FIG. 2 shows a mobile electronic device 68 (such as a mobile phone) having self-checkout software loaded thereon. The mobile electronic device 68 may display shopping cart information 52 as well as competition information 46. The shopping cart information 52 may be an electronic shopping cart which shows the various items which have been selected by the customer for purchase. In some cases, the shopping cart information may display items selected by other customers for purchase, such as where a group of persons are shopping together. The competition information 46 may display desirable information related to any competition involving the customer. The competition information 46 may display points that the customer has earned while shopping and may also display points earned by other customers involved in that competition.

While shopping, the customer may select an item 70 for purchase and may use the mobile electronic device 68A to capture a UPC code 72 on that item. The mobile self-checkout software on the mobile electronic device may, from the UPC code 72, obtain and store information regarding the product 70. The customer may receive points for the selected item. These points may be added to any points the customer has already earned and the points may be displayed to the customer along with an indicator of how the customer is performing in a competition. The customer may proceed in this manner while shopping, selecting items for purchase, capturing the UPC code associated with that item, and creating an electronic shopping cart on the mobile electronic device 68 which includes a list of items selected for purchase.

In a similar manner, another customer who is in competition with the first customer may also select an item 74 for purchase and may use their mobile electronic device 68B to capture a UPC code 72 on that item. The mobile self-checkout software on the mobile electronic device may, from the UPC code 72, obtain and store information regarding the product 70. The second customer may receive points for the selected item. The second customer may proceed in this manner while shopping, selecting items for purchase, scanning the UPC code associated with that item, and adding these items to an electronic shopping cart.

In some cases, the first customer and second customer may be friends, members of the same family, etc. and may have come together to the store for shopping. As the first customer and second customer are shopping together at the store, they typically have common interest in the products selected for purchase by each other and may have created a shopping list together or otherwise discussed which items needed to be purchased at the store. A single shared electronic shopping cart may be created by the first customer and the second customer and this cart may be displayed on each of their electronic devices 68A, 68B.

As one of these customers selects an item for purchase and scans the UPC code 72 from the item, the item may be added to the electronic shopping cart and displayed on both mobile electronic devices 68A, 68B. The electronic shopping cart may include information regarding which of the customers selected the item and may provide such information to each of the customers to assist them in managing the electronic shopping cart and in being aware of what the other customer has selected and added to the shopping cart. The customers may also be allowed to send comments, notifications, or requests to each other via the mobile self-checkout software. These communications may allow the customers to easily communicate about the selected items or other aspects of the shopping trip including the competition between the customers.

When the customer(s) is ready to checkout and pay for the selected items, the customer may finalize the shopping cart. The customer will typically approach a POS terminal 10 to complete the purchase. The POS terminal 10 may be a self-checkout register or a conventional sales register with a cashier. The customer will typically have a physical shopping cart or basket with the selected items and will have an electronic shopping cart containing information about those items on a mobile electronic device 68. The customer may indicate on the mobile electronic device that they are ready to checkout. In response, the mobile electronic device 68 may prepare information for the POS terminal 10 to convey the electronic shopping cart (list of items for purchase) to the POS terminal.

In some situations, the mobile electronic device 68 may prepare one or more machine readable codes, such as a 2D barcode or QR code, which have information regarding the selected items. The 2D machine readable codes can convey significant amounts of information, allowing one or more machine readable codes to convey item and quantity information to the POS terminal. An optical scanner 16a associated with the POS terminal 10 may be used (either by the customer at a self-checkout lane or by a cashier at an assisted checkout lane) to capture the machine readable code(s) and thereby receive information regarding the selected items for purchase.

In other situations, the mobile electronic device 68 may transmit the electronic shopping cart information to the POS terminal 10 via the server 34 or via other communication channels. The customer may then proceed with the checkout and payment process. In finalizing shopping and proceeding with the checkout process, the customer(s) may also complete the competition. Where a customer is in competition with unknown individuals, the checkout process may complete the customer's involvement with the competition and the customer may await the results as other customers complete their shopping, and thus their part in the competition. Where customers are shopping together, such as members of a family who are shopping together, finalizing the shopping cart for purchase may finalize the competition for all involved customers and these customers may be provided with results.

Customers may be provided with a prize or reward for winning the competition. In some cases, the customers may be provided with a reward which is of no commercial value, such as having their name posted on a winner board at the store or on a website. In some cases, customers may be provided with financial rewards. Winning customers may be provided with a discount on the present or a future purchase or may be provided with a coupon for items which they frequently purchase. Winning customers may also be provided with a small prize such as a small snack or treat. In some situations, a larger competition may be held, such as by providing a competition between various customers during an extended time period. By way of example, a competition may be held to determine which customer earns the highest amount of points during a month, quarter, or year. This customer may be provided with a prize. To facilitate such an extended competition, normalizing of the customer scores may be performed such as by dividing the customer points by the number of items or by the amount of time required to acquire those items.

Various parts of a POS system and self-checkout system may allow multiple customers to participate in a competition while shopping. Various parts and structures are described to illustrate how these may allow a customer or group of customers to compete in a competition and to complete a purchase.

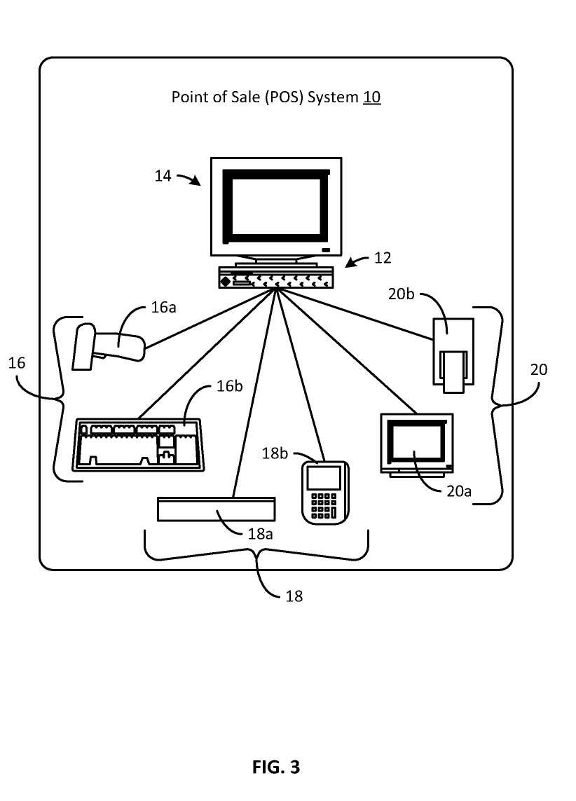

Referring to FIG. 3, in selected embodiments, the hardware, software, or hardware and software of a POS system 10 may be configured to implement one or more embodiments described herein. For example, a POS system 10 may be manufactured, programmed, modified, or upgraded to support communications with mobile electronic devices 68 and to thereby facilitate competitions whereby one or more customers create electronic shopping carts while selecting items in the store and receive points for selected items. It is appreciated that the POS system may involve one or more parts of a local POS terminal and associated computers or servers, remote computers or servers, customer devices such as a mobile electronic device, and associated equipment.

A POS system 10 may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support communications with mobile electronic devices 68, inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 may include an accounting interface to pass certain information to one or more in-house or independent accounting applications. A POS system 10 may also communicate with third parties and may transmit receipt information and facilitate customer management of receipts.

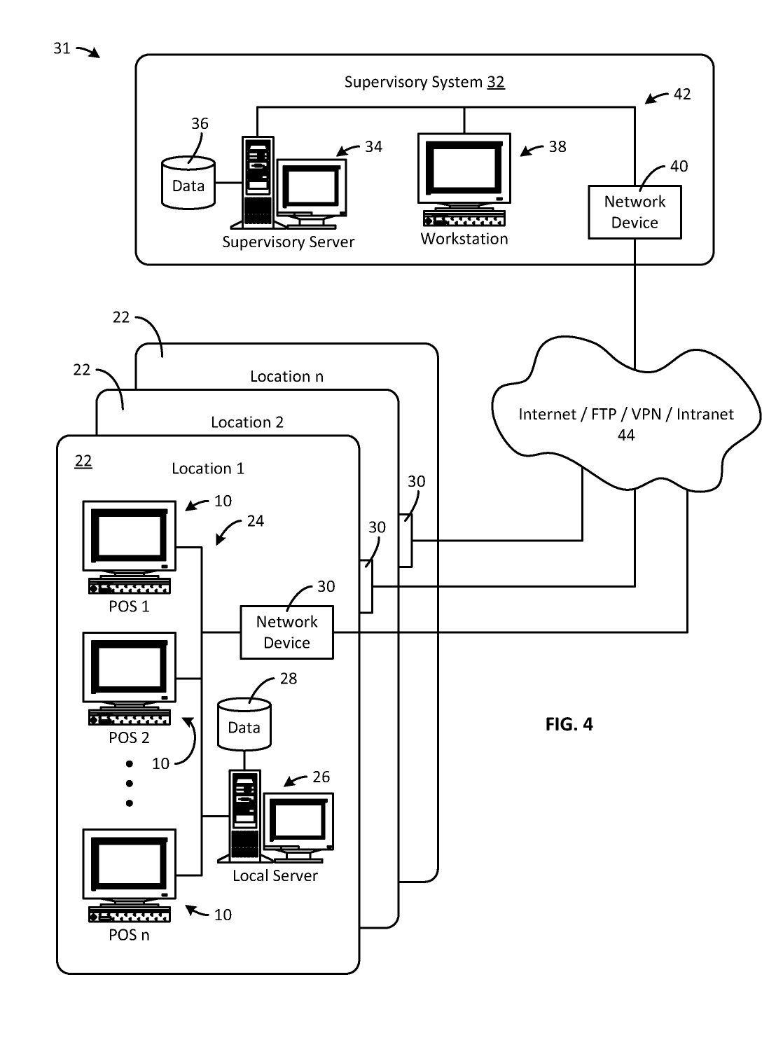

Referring to FIG. 4, in selected embodiments, a POS system 10 may operate substantially independently, as a stand-alone unit. Alternately, a POS system 10 may be one of several POS systems 10 forming the front line of a larger system. For example, multiple POS systems 10 may operate at a particular location 22 (e.g., within a brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system 32.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more supervisory servers 34 providing a central repository from which certain data needed by the one or more POS systems 10 or local servers 26 may be stored, indexed, accessed, or the like.

Alternatively, or in addition thereto, a supervisory server 34 may receive and compile (e.g., within one or more associated databases 36) data from the various associated POS systems 10 or local servers 26 to provide or support inventory control, purchasing, receiving and transferring products, or the like. A supervisory server 34 may also receive and compile sales and customer information for reporting purposes, marketing purposes, receivables management, trend analysis, cost analysis, price analysis, profit analysis, or the like.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

It is thus appreciated that in discussing the functionality of the various POS terminals and servers, the embodiments described herein may be implemented in a system contained within a single location or across multiple locations. By way of example, the functionality accomplished by a server or computer, such as storing, processing, and transmitting/sending receipt information, may be accomplished by a local computer or a remote computer such as servers 26 and 34.

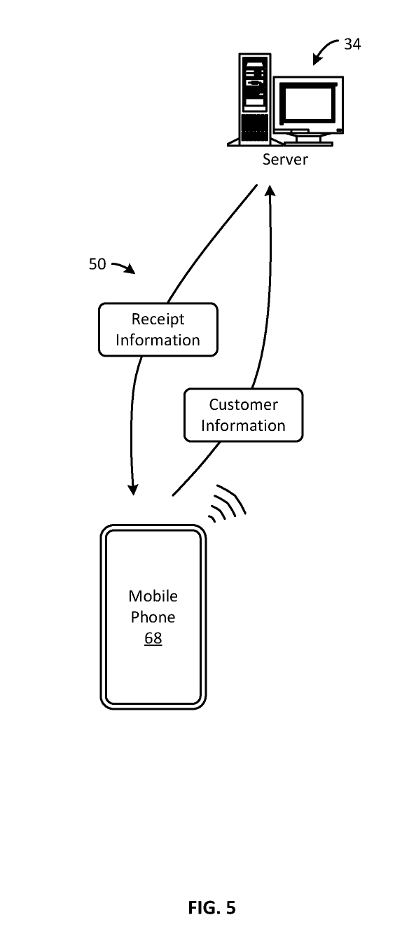

Referring to FIG. 5, customers may use a mobile electronic device 68 while shopping. The mobile electronic device may be a mobile phone such as a smart phone, a tablet computer, etc. In many instances, the mobile electronic device 68 is a mobile phone. The customer may download or may already have downloaded self-checkout software to a mobile electronic device 68. A customer may have previously received an invitation to download and use self-checkout software from a paper receipt, friend, in-store advertisement, website, etc. and may have installed self-checkout software on the mobile electronic device 68.

As indicated at 50, the customer may have created an account with a receipts/shopping server 34 (or server 26) and may transmit information to the server 34. The computer server 34 may likewise transmit information to the mobile device 68. The customer may receive self-checkout software on the mobile device 68 which may enable them to manage their in-store shopping experience with their mobile electronic device. Additionally, the self-checkout software may allow the customer to interact with a POS system 10 via the mobile electronic device 68. The server 34, server 26, or other devices may facilitate communication with the mobile electronic device 68 and between the mobile electronic device 68 and the POS terminal 10. Multiple customers may download self-checkout software as discussed above. If desired, these customers may create accounts with the server 34.

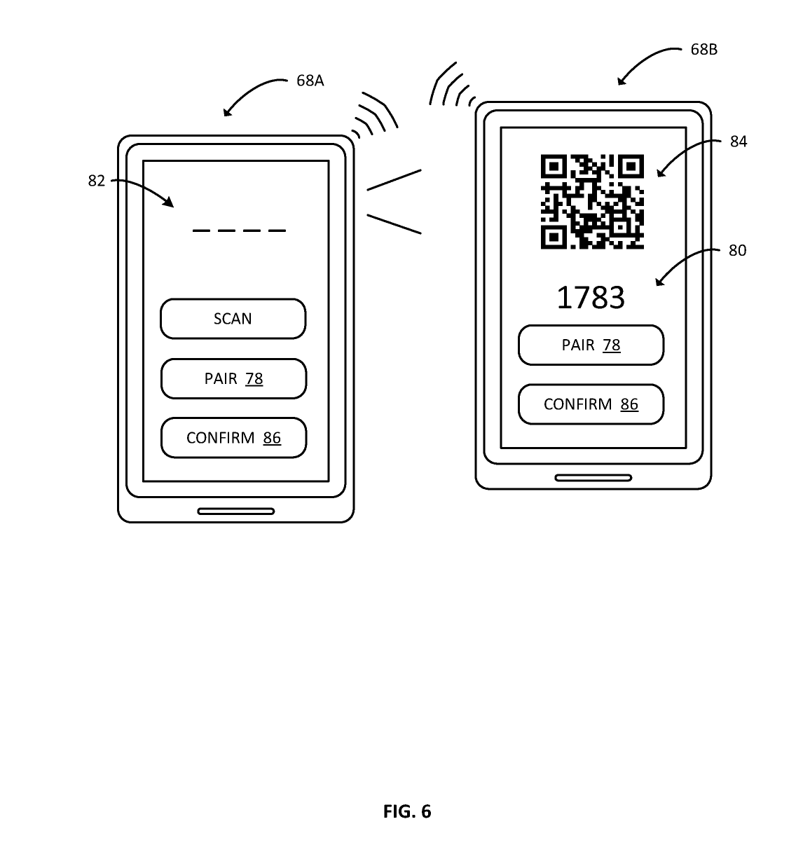

Referring to FIG. 6, two or more customers who are shopping may desire to enter a competition. In one situation, these customers may be shopping together. These customers may be friends or family members who are shopping together. These customers may desire to create a single electronic shopping cart while shopping. The customers may first pair their mobile electronic devices 68A, 68B. These customers would typically enter self-checkout software on their mobile electronic devices 68A, 68B and may then enter a competition or shared shopping function in the software. Each of the customers may press a pair button 78 to pair the mobile electronic devices 68A, 68B together. The customer may enter an identification number such as a device telephone number for the other mobile electronic device before pairing to facilitate communications between the devices. In pairing the mobile electronic devices, it may be desirable to identify the devices so that each device knows the identification of the other device(s) so that information can be transmitted between the devices. In pairing the mobile electronic devices 68A, 68B, it may be desirable that the devices are identified together as paired through a common code and that a server 34 receives identification for each device, such as the device telephone number, and receives a code identifying the devices as paired. The server 34 may then facilitate communications with each device.

The devices may be paired together in multiple different ways. One of the mobile electronic devices 68B may produce a unique sound and the other mobile electronic device 68A may capture that sound to identify the two devices. One device 68B may create a pin number 80 and a customer may enter the pin 80 into an appropriate data field 82 on the other device 68A. One mobile electronic device 68B may create a machine readable code 84 such as a QR code and the other device(s) 68A may capture the code 84 with a camera. The devices 68A, 68B may be bumped together and may record the vibrations from the bump. A text message with a code may be sent from one mobile electronic device 68A to the other mobile electronic device 68A. Multiple different ways may be utilized to pair these mobile electronic devices together.

During the pairing process, one device 68B may provide the created code 80, 84, etc. to a server 34 which facilitates self-checkout and communications between devices. The other device 68A may provide the received code to the server 34 and the server may identify the codes which it receives and match the devices 68A, 68B together. The server may provide information to the devices 68A, 68B, such as providing a telephone number or device identification number for the devices to facilitate communication between the devices.

In these methods of pairing the devices together, each device 68A, 68B is party to a particular code or piece of information which identifies the devices with a particular transaction; that of joining together for shopping at the store. Pairing the devices 68A, 68B together may provide each device with a device identification such as a telephone number for the other paired device(s) and may thus facilitate communication between the devices.

In addition to the above, the self-checkout software may utilize additional information to identify the mobile electronic devices and pair them together. If desired, the self-checkout software may use geofencing or device proximity to assist in identifying the devices which are being paired together. The server 34 or self-checkout software may use geofencing to confirm that the devices which are being paired together are all in geographic proximity to each other, such as being in proximity to a store. The server 34 or self-checkout software may also use device proximity, such as verifying that the devices being paired are on the same WIFI network. The use of geofencing or device proximity may assist the server 34 or software to identify the devices which are intended to be paired together. In pairing multiple mobile electronic devices 68 together, customers may select to form a single electronic shopping cart. This may be useful where family members are shopping together, for example. After entering, capturing, or transmitting information used for pairing the devices together, the customers may press a confirm button 86 to finalize the device pairing.

For the present discussion, two mobile electronic devices 68A, 68B are discussed. It is appreciated that more than two devices 68 may be paired together as more than two customers shop together and engage in a competition. Once paired, the devices 68A, 68B may communicate with each other while the customers are shopping at the store. The devices may communicate through a device network such as a cellular network or WIFI accessed internet. The server 34 may facilitate communication between the devices 68A, 68B. The store may provide WIFI access to the devices 68A, 68B to facilitate communication.

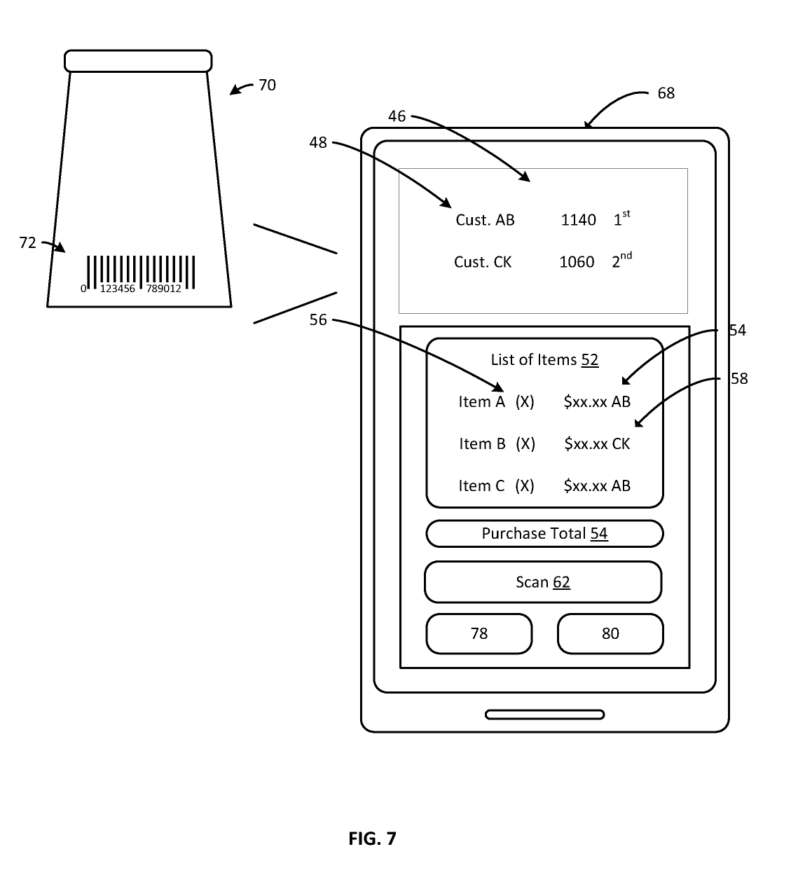

Referring now to FIG. 7, after pairing, a customer may use the mobile electronic device 68 while shopping in the brick and mortar store. In particular, the customer may use the mobile electronic device 68 to scan barcodes such as UPC codes 72 on products 70. A camera on the mobile electronic device 68 may be used to capture the UPC code 72. Mobile self-checkout software loaded onto the mobile electronic device 68 may provide this functionality to the customer, allowing the customer to use the mobile electronic device 68 to capture UPC codes 72 on products 70 as the customer selects these items for purchase in the store. The customer will typically advance through a store selecting physical items 70 for purchase. The customer may select an item 70, capture a UPC code 72 from the item, and place the item in a physical shopping cart or basket for purchase.

Upon capturing a UPC code 72, the self-checkout software may allow the mobile electronic device 68 to receive information about the product. The self-checkout software may obtain information about the product 70 and create an electronic shopping cart with the item information. The mobile self-checkout software may provide a user interface on the device 68 as shown. The self-checkout software, through the mobile electronic device 68, may display a list 52 of selected items/products (i.e. an electronic shopping cart) to the customer as the customer selects these for purchase. Additionally, the self-checkout software may display competition information 46 on the mobile electronic device. The competition information may include competition status 48, such as by indicating the customer, the points that the customer has accumulated, and the position that the customer is in. The composition information 46 may include this information for other customers who are competing together, making it easier for a customer to view their position in the competition relative to the other customers.

As part of the electronic shopping cart, the self-checkout software may display the cost 54 of an item next to the item. This may require additional information from the customer or store, as this information may not be conveyed with the UPC code. The software may allow the customer to enter in the price of the item while selecting this item, as well as the quantity 56 of the item which the customer is purchasing. If this information is acquired, the mobile self-checkout software may display this information in the list of items 52 in presenting the electronic shopping cart to the customer.

In some situations multiple friends, family members, etc. may be shopping together to make a single purchase and may have selected to create a single electronic shopping cart. The self-checkout software may facilitate communication between multiple customers who are contributing items to the electronic shopping cart and may facilitate creation of a single electronic shopping cart for a group of customers. While shopping, the mobile electronic devices 68A, 68B may communicate with each other such that modifications to the electronic shopping cart made by one customer are shared with the other customer. Each customer may have an updated electronic shopping cart which includes the items selected by other paired customers.

The mobile electronic devices 68A, 68B may communicate with each other via the device's own communications network. The devices 68A, 68B may often be cellular phones and may use the cellular network to communicate. Information for the electronic shopping cart such as item information may be transmitted between the mobile electronic devices 68A, 68B and the devices may thus maintain an updated electronic shopping cart with items selected by each customer.

A computer associated with the store such as server 34 may facilitate communication between the mobile electronic devices 68A, 68B. The server may store and/or transmit information between the mobile electronic devices 68A, 68B. The devices may periodically poll the server to obtain any updates to the electronic shopping cart such as additional items. The server 34, upon receiving a polling request, may transmit shopping cart information to the mobile electronic device 68 to update the electronic shopping cart on the device. The server 34 may ensure that the electronic shopping cart is displayed correctly on each mobile electronic device 68A, 68B without discrepancy, and may periodically transmit a complete copy of the electronic shopping cart to a mobile electronic device to ensure accuracy.

The self-checkout software may also display information 58 conveying who scanned a particular item and added that item to the electronic shopping cart. By way of example, the self-checkout software may display a person's mobile phone number, email, avatar, initials or name along with an item in the electronic shopping cart list 52 to indicate that a particular person selected that item and scanned that item to place the item in the electronic shopping cart. According to another example, an electronic shopping cart list 52 of items may be divided into separate columns or horizontal sections for each customer, indicating which customer added the various items to the electronic shopping cart. This may allow a customer to more easily track and manage the electronic shopping cart; being particularly useful where customers are shopping together and may wish to provide feedback or instructions to each other.

The self-checkout software may allow a customer to modify the electronic shopping cart by selecting an item on the list 52 of items. In this manner, a customer may select an item on the list 52, such as by pressing the list item entry on a touch sensitive screen, and then enter a menu command such as a command to remove the item from the electronic shopping cart. If desired, the self-checkout software may require that a customer who added an item to the electronic shopping cart remove that item from the electronic shopping cart.

The self-checkout software may also provide the customer with additional purchase information such as the total purchase cost 60, which may include a tax amount, as the customer selects products for purchase. This may assist the customer in understanding how much they are spending and in otherwise completing their purchase. If desired, the electronic shopping cart may also transmit additional item information such as item name, brand, description, and/or picture may be included in the electronic shopping cart and may be transmitted between the customers to assist in the shopping process.

The self-checkout software may provide additional functionality to the customer, such as through virtual buttons 62, 64, 66 or other menu commands. By way of example, a virtual button 62 may be provided to allow a customer to capture a UPC code from an item. Such a virtual button may cause the self-checkout software to operate a camera which is part of the mobile electronic device to capture the UPC code. Virtual button 64 may be used to send a message to another customer, such as a message regarding items in the electronic shopping cart or other items or tasks related to the shopping trip. A virtual button 66 may be used to finalize the shopping trip and enter a checkout mode.

As the customer selects items for purchase and adds these items to the electronic shopping cart, the customer may be awarded points for each item they have added to the shopping cart. Where multiple customers are shopping together, they may have previously created a shopping list of items which they intend to purchase. In some situations, this shopping list may be created electronically on the self-checkout software. The shopping list may be divided among the customers to assign each customer with items that they are responsible for finding at the store. Alternatively, each customer may race to find items before another customer finds the item.

If desired, a customer may assign point values to each item on the shopping list and these values may be awarded to each individual customer as they acquire each item for purchase. Alternatively, the server 34 may assign point values to each item. The server 34 may assign a point value to each item according to how quickly a customer finds the item. The server 34 may thus monitor the time between selected items for a customer. The server 34 may assign a point value to each item according to an item attribute such as weight, size, price, color, etc. The server 34 may assign a point value to each item according to the relative difficulty in finding the item, accounting for the location of the item in the store, etc. The server 34 may assign point values to the items based on store sponsorship of particular items or brands or based on sponsorship by the product manufacturer. Manufacturer sponsorship may include providing item discounts, coupons, or prizes. The server 34 may also assign point values according to the order in which items are scanned, may randomly assign point values to the items, and may assign bonus items which are worth more points than usual. It will be appreciated that where the server 34 assigns point values to items, it is not necessary to provide the server 34 or self-checkout software with any shopping list and no limitation need be placed on the items selected for purchase.

The server 34 may also use a handicap to reduce the point discrepancy between customers in a competition. If the server 34 knows that a customer is a young child, the server may give more points to the customer for each item. The server 34 may decrease the item points for a customer who is leading by a large margin and may increase the item points for a customer who is behind by a large margin. In this manner, the server 34 may help maintain interest in the competition.

As discussed, the mobile electronic device 68 may display the competition status 48. The competition status 48 may provide point totals for each customer in a competition which are updated each time that a customer adds an item to an electronic shopping cart. Each customer may see the competition status in real time.

The competition may end when the electronic shopping cart is finalized for checkout or when the electronic shopping cart has been delivered to a POS terminal 10 for purchase. If desired, customer points may be normalized, such as by calculating points per item. The customer who has the most points may be declared the winner and may be awarded a prize. In some examples, the prize may be of no monetary value. The customer may be added to a board of other winners and may be ranked according to their performance. In some examples, prizes may have some monetary values. A winning customer may be provided with a coupon for a small prize such as a snack food or other treat. A winning customer may also be provided with an electronic gift card or a coupon for a purchase discount or an item discount. An item discount may be for an item commonly purchased by the customer. For a family situation, a parent may select a small prize for children and release the prize to the winner after the competition.

In some situations, a customer who is shopping alone may desire to enter a competition. The customer may desire to enter a competition with unknown customers at the same or a different store. The customer may enter self-checkout software on a mobile electronic device 68 and may then enter a competition mode in the self-checkout software. In order to facilitate entering a competition round as well as facilitating many other aspects of shopping, the mobile electronic device 68 may communicate with a server 34 which may manage and provide information to the mobile electronic device as well as facilitate communication with the mobile electronic device.

The customer may then sign into a competition round which may involve other customers shopping at the same brick and mortar store or which may involve other customers shopping at other brick and mortar store locations which may typically be part of the same store chain. In such a situation, the customer may not be starting and completing a shopping trip at the same time as other customers. The customer may sign into a particular competition round to avoid such a problem. The server may provide a window for the competition, such as providing a 30, 45, or 60 minute window for the competition. These windows may be both of a fixed duration and fixed in time. As such, the windows may be for a defined part of the day, such as being between 10:00 AM and 10:30 AM. The window may provide time limitations where a customer must start and end shopping within the time window to qualify for the competition. This may allow a competition to be completed within a known time period and may make it easier for a customer to enter such a competition.

The server 34 may also limit the competition in other ways. For example, the server may limit a competition to a fixed number of customers. A competition may be limited to 10, 20 or another desired number of customers. The server may also limit a competition to a particular number of items. A customer who desires to enter a competition may indicate that they want to purchase up to 10 items, between 10 and 20 items, between 20 and 30 items, etc. Alternatively, a customer may indicate the approximate number of items that they want to purchase and the server may enter the customer into a competition with other shoppers having a similar number of items. The server may also allow a customer to simply complete a shopping trip and, upon checkout, group the customer's score with other customers who purchased a similar number of items.

Where a customer is shopping against other unknown persons, it is appreciated that it is typically not feasible for the customer to assign points to their purchase items. In such a situation, the server 34 will typically assign points to the items. Such an assignment will typically be made according to item bulk, price, difficulty to find the item, product manufacturer sponsorship, customer shopping speed, randomness, etc. In this manner, the self-checkout software and/or server 34 may allow a customer to participate in a competition against other known or unknown persons.

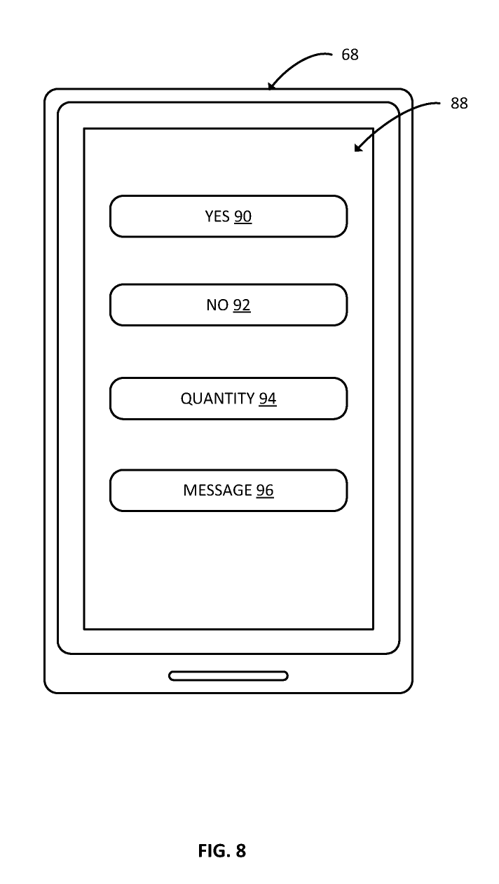

Referring to FIG. 8, the self-checkout software may provide additional notification and communication screens to assist the customers while shopping. Such notification/communication screens may be particularly useful where a group of customers are shopping together in a competition, such as where friends or family members are shopping together. The notification/communication screens may be particularly useful where a group of customers are creating a combined electronic shopping cart while shopping.

The self-checkout software may display a notification screen 88 when another paired customer selects an item and scans a UPC code on the item to add the item to the electronic shopping cart. The notification screen 88 may include virtual buttons (i.e. a button or area of a touchscreen user interface which is created by the self-checkout software which, when touched by a user, performs a designated function) for commonly used messages or responses to the customer who selected the item. The notification screen may thus include a virtual button 90 which indicates YES to select that item for purchase and pressing this button may transmit such a message to the customer who scanned that item. Another virtual button 92 may indicate that NO, the item is not to be purchased, and may further include or provide subsequent options to indicate that the customer who selected the item should not purchase such an item or should get another brand, size, or type of the item.

A virtual button 94 may be included which allows a customer to quickly enter a suggested quantity for the scanned item and transmit such a message to the customer who scanned the item. A button 96 may allow a customer to quickly enter a message, such as with a virtual keyboard or voice recognition, and send that message to the customer who scanned that item. In this manner, the self-checkout software may allow a customer to quickly and easily send messages to other customers who are paired together and creating a common electronic shopping cart. Sending such messages within the self-checkout software may be more convenient than exiting the software and using telephone or text messaging software on the mobile electronic device to send the messages.

When a customer has finished selecting items for purchase in the store and desires to checkout, they will typically press a checkout button 66 to indicate this on the mobile electronic device 68. Pressing the checkout button may end the customer's participation in a competition and may cause the server 34 to determine or store a customer's final score. Alternatively, such a score determination may be made upon completion of the checkout process. Pressing a checkout button 66 may cause the self-checkout software to send a notification to other customers who are paired together with this customer that a checkout mode has been entered or that a customer in the group desires to checkout. The other paired customer may be provided with an option, such as another virtual button, to indicate that they desire to continue shopping or that they are finished shopping.

If desired, the self-checkout software may allow a customer to easily return to a shopping mode from the checkout mode. The software may allow a customer to press a button or enter a menu command to return to a shopping mode and add additional items to the electronic shopping cart. The self-checkout software may also allow a customer to capture an additional UPC code for an item and thereby return to a shopping mode.

Pressing a checkout button 66 may cause the mobile self-checkout software to enter a checkout mode. To facilitate checkout, the customer may pair their mobile electronic device 68 with the POS terminal. In some situations, pairing the mobile electronic device 68 with the POS terminal and indicating on the device to checkout may transfer the electronic shopping cart information to the POS terminal. The customer may pair with the POS terminal by scanning a machine readable code such as a 2D barcode at the POS terminal. The server 34 may then transmit electronic shopping cart information to the POS terminal. The software or server 34 may prepare the electronic shopping cart/list 52 of selected items for checkout. The software or server 34 may process information regarding the selected products 70, 74, etc. for transmittal to a POS terminal 10. Typically, the mobile self-checkout software may provide identifying information such as the numeric UPC code 72 and product purchase quantity to the POS terminal 10. The server 34 may transmit this information to a POS terminal 10.

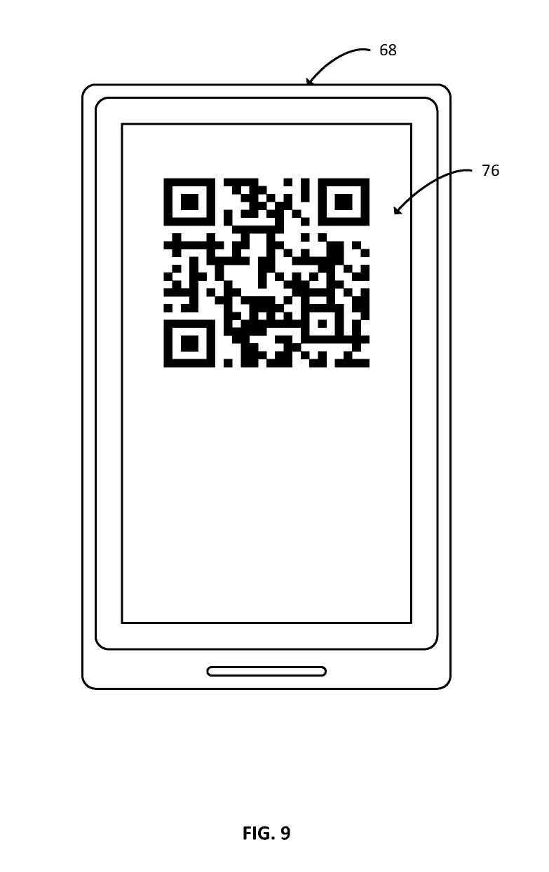

Referring to FIG. 9, the software may alternatively take the data from the item list 52 such as the UPC code 72 (e.g. the numeric equivalent) and item quantity and embed this information within a machine readable code 76 as a payload. The mobile self-checkout software may shorten or append the UPC codes, such as by appending these codes into the last five numbers of the code, allowing for greater information capacity in the machine readable code 76.

The machine-readable code 76 may comprise a two-dimensional barcode. Two-dimensional barcodes may support or provide more data per unit area than can be obtained using a traditional one-dimensional barcode. A two-dimensional barcode may follow any suitable protocol, format, or system. In selected embodiments, a two-dimensional code may be embodied as a Quick Response (QR) Code or a High Capacity Color Barcode. A single such code 76 may convey UPC and quantity information for many products to the POS terminal.

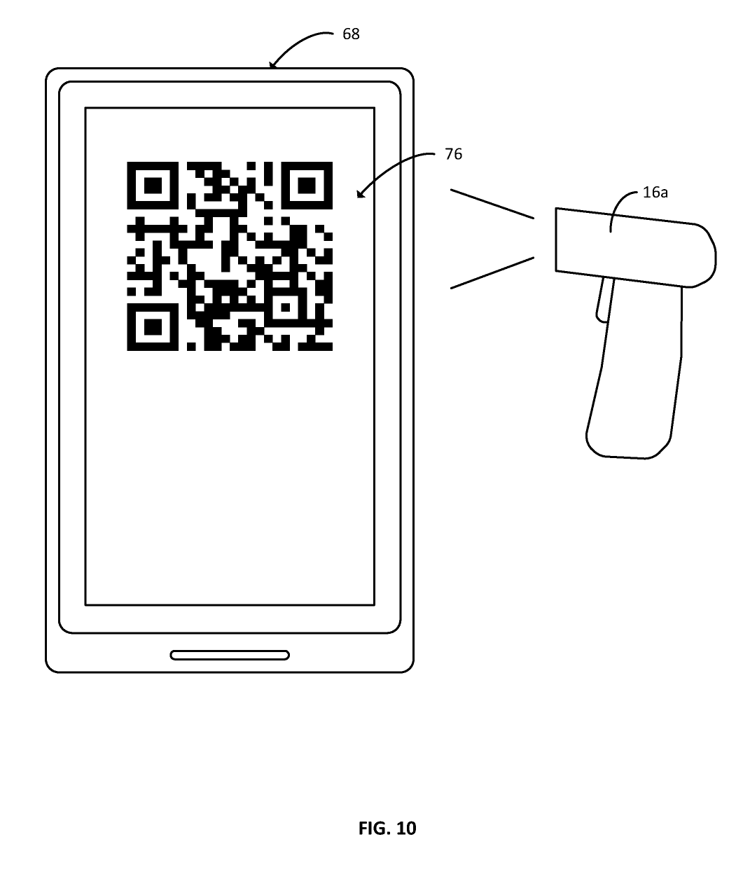

As indicated in FIG. 10, an optical scanner 16a at a POS terminal 10 (not shown for clarity) may be used to capture the machine readable code 76 produced on the mobile electronic device 68 and thus acquire UPC and/or product quantity information for the POS terminal. It will be appreciated that the optical scanner 16a may differ according to the POS terminal. For example, in a self-checkout lane the customer may use an optical barcode scanner which is integrated into the POS terminal to capture the machine readable code 76. At a conventional checkout lane with a sales associate operating a POS terminal, the sales associate may use a handheld scanner 16a to capture the machine readable codes 76 from the mobile electronic device.

In some cases, the customer may have selected a greater number of products than can be carried within a single machine readable code 76. In this situation, the software can create a sequence of multiple different machine readable codes 76. These machine readable codes 76 may be displayed sequentially on the mobile electronic device 68 and captured by the scanner 16a. Where multiple machine readable codes 76 are prepared by the mobile self-checkout software, the first code 76 may identify itself as the first and the sequence may be quickly flashed (cycled) to the scanner as the scanner reads the multiple codes 76. If desired, each machine readable code 76 in the sequence can identify itself (1/4), (2/4), etc.

Alternatively, the first machine readable code 76 may indicate that it is number (1/4) and may provide a checksum for the whole payload. These pieces of data in the machine readable codes allow the POS terminal to determine if it received the entire series of machine readable codes 76. Some 2D barcodes have redundancy for error correction. If desired, the self-checkout software may lower the amount of redundancy checks to increase the payload data in the code.

While scanning the machine readable codes, the scanner 16a or POS terminal 10 can indicate, such as with a beep, after receiving the machine readable codes 76. The scanner 16a or POS terminal 10 may indicate if the receipt is successful or not successful, such as with a beep. The scanner 16a or POS terminal 10 may timeout if data is not received. The scanner 16a can operate for a fixed time period to acquire the machine readable codes.

In this manner, the information regarding the customer's selected products, such as UPC codes and quantity, may be provided from the mobile electronic device 68 to the POS terminal 10. This transfer of electronic shopping cart information is robust and may be completed without the use of any network connection or data connection between these devices. This may facilitate a successful transfer of the desired data and promote customer satisfaction.

The electronic shopping cart information may be transferred to the POS terminal in different ways. By way of example, a customer may approach the POS terminal 10 and use their mobile electronic device 68 to enter a code or capture a machine readable code at the POS terminal. The mobile electronic device may communicate with a server 34 and the code may identify the POS terminal 10 to the server 34, effectively pairing the mobile electronic device 68 and the POS terminal 10 by identifying both of these to the server 34 for communication purposes. The customer may press a button on the mobile electronic device 68 or otherwise transmit the code to the server and thereby pair the mobile electronic device 68 with that POS terminal 10. This pairing may cause the server 34 to transmit the electronic shopping cart information to the POS terminal 10.

After transmitting the electronic shopping cart information to the POS terminal 10, the customer may proceed with the checkout and payment process. A customer with self-checkout software on a mobile electronic device may have typically elected to receive electronic receipts on the mobile electronic device. The POS terminal 10 and server 34 may then transmit an electronic receipt to the mobile electronic device for the purchase.

In some situations, multiple customers may have contributed items to a shared electronic shopping cart. In these situations, the server 34 may transmit electronic receipts to each customer associated with the shared electronic shopping cart. The customer who paid for the purchase may receive a fully functional electronic receipt which may be used for returns and other such related transactions. Other customers associated with the electronic shopping cart who did not pay for the transaction may be provided with electronic receipts which may not be used for returns, and the electronic receipt may be marked to indicate that it is not usable for returns.

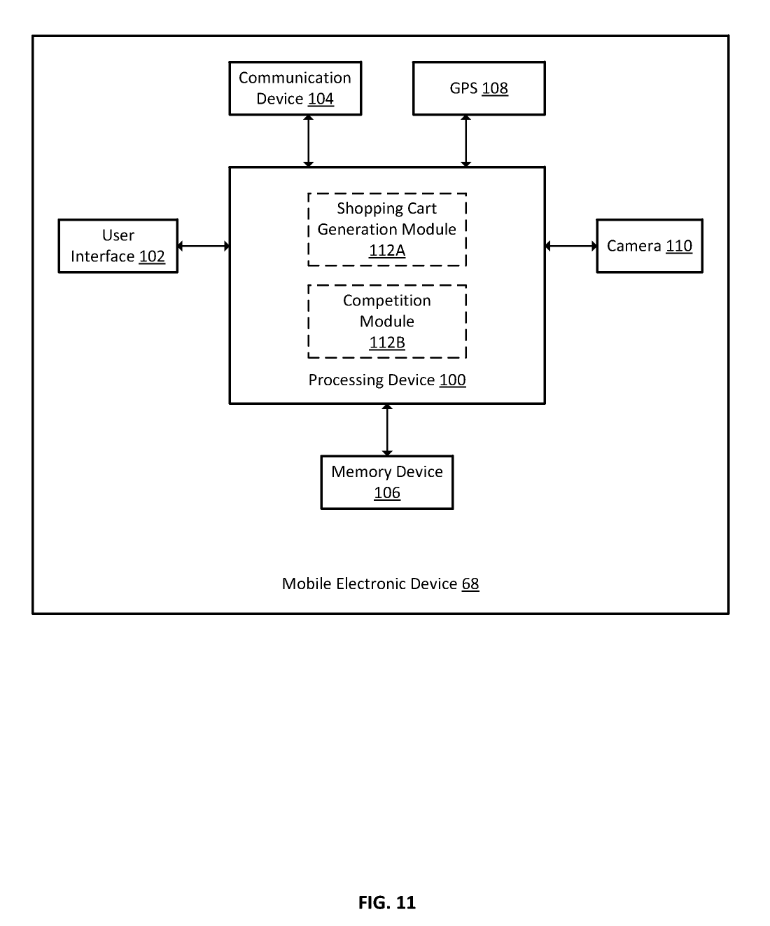

Referring now to FIG. 11, a schematic illustrating example components of the mobile electronic device 68 of FIG. 1 is illustrated. In the illustrative embodiment, the mobile electronic device includes a processing device 100, a user interface 102, a communication device 104, a memory device 106, a global positioning system (GPS) 108, and a camera 110. It is noted that the mobile electronic device 68 can include other components and some of the components are not required.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the mobile electronic device 68. In the illustrative example, the processing device 100 also executes an electronic shopping cart generation module 112 which is described in greater detail below.

The user interface 102 is a device that allows a user to interact with the mobile electronic device 68. While one user interface 102 is shown, the term “user interface” can include, but is not limited to, a touch screen, a physical keyboard, a mouse, a microphone, and/or a speaker. The communication device 104 is a device that allows the mobile electronic device 68 to communicate with another device, e.g., the server 34 or another mobile electronic device. The communication device 104 can include one or more wireless transceivers for performing wireless communication and/or one or more communication ports for performing wired communication. The memory device 106 is a device that stores data generated or received by the mobile electronic device 68. The memory device 106 can include, but is not limited to, a hard disc drive, an optical disc drive, and/or a flash memory drive.

The GPS 108 determines a location of the mobile electronic device 10 by communicating with a plurality of GPS satellites. The GPS 108 can perform known triangulation techniques to determine the GPS coordinates of the mobile electronic device 68. It should be appreciated that while a GPS 108 is shown, any other suitable component for determining the location of the mobile electronic device 68 can be implemented.

The camera 110 is a digital camera that captures a digital photograph or video. The camera 110 receives an instruction to capture an image such as a UPC code 72 from an item selected by a customer, captures an image of the object, and outputs the captured image. The camera 110 can receive the instruction to capture the image from the processing device 100 and can output the digital photograph to the processing device 100.

The electronic shopping cart generation module 112A allows a user to generate an electronic shopping cart and displays the electronic shopping cart to the user via the user interface 102. As discussed previously the shopping cart generation module 112A may be configured to generate the electronic shopping cart based on items scanned by a customer while shopping. The electronic shopping cart module 112A may receive images from the camera 110 and may utilize the communication device 104 to communicate changes to the electronic shopping cart with other paired customers who are contributing items to the same electronic shopping cart.

The competition module 112B allows a user to participate in a competition with other customers while shopping and may display the results of such a competition to the user via the user interface 102. The competition module 112B may receive point values for items scanned by a customer while shopping. The competition module 112B may communicate with a server 34 via the communication device 104 and may provide the user with information regarding other customers who are participating in a competition.

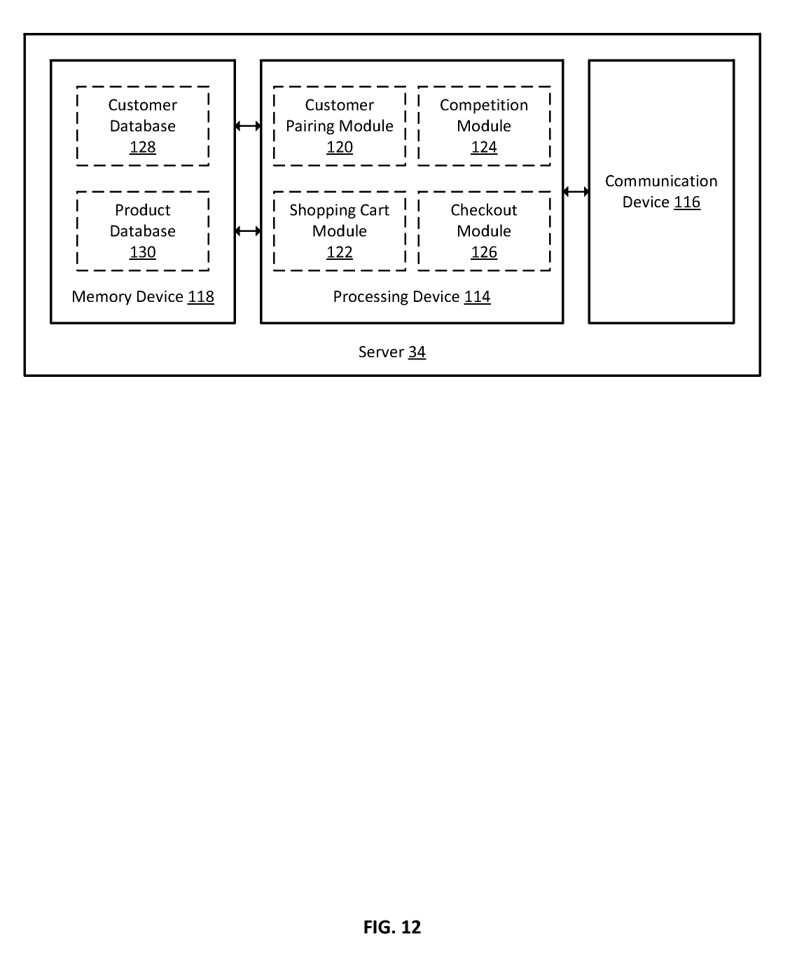

As referenced above, the server 34 may be configured to perform one or more functions at the request of the mobile electronic device 68. FIG. 12 illustrates an example embodiment of the server 34 configured to perform one or more of the requested functions. In the illustrated embodiment, the server 34 may include a processing device 114, a communication device 116, and a memory device 118.

The processing device 114 can include memory, e.g., read only memory (ROM) and random access memory (RAM), storing processor-executable instructions and one or more processors that execute the processor-executable instructions. In embodiments where the processing device 114 includes two or more processors, the processors can operate in a parallel or distributed manner. In the illustrative embodiment, the processing device 114 executes one or more of a customer pairing module 120, a shopping cart module 122, a competition module 124, and a checkout module 126.

The communication device 116 is a device that allows the server 34 to communicate with another device, e.g., the mobile electronic device 68. The communication device 116 can include one or more wireless transceivers for performing wireless communication and/or one or more communication ports for performing wired communication.

The memory device 118 is a device that stores data generated or received by the server 34. The memory device 118 can include, but is not limited to a hard disc drive, an optical disc drive, and/or a flash memory drive. Further, the memory device 118 may be distributed and located at multiple locations. The memory device 118 is accessible to the processing device 114. In some embodiments, the memory device 118 stores a customer database 128 and a product database 130.

In some embodiments, the customer database 128 can store information associated with a customer. The customer database may, for example, store information associated with a customer account and may include account preferences and customer contact information associated with a particular customer. The customer database may be queried by the processing device 114 and may provide information to the processing device to facilitate pairing customers together and to facilitate communications with the customers.

In some embodiments, the product database 130 stores product information for products sold by a retailer in the brick and mortar store. For example, the product database 130 may store information such as the name, brand, description, image, or price associated with products in the store. By way of example, the product database 130 may be queried by the processing device 114 and may transmit information to the processing device to facilitate the creation of an electronic shopping cart. The product database 130 may also store information regarding points which are associated with a product for a competition. The server 34 may store rules for calculating product points, sponsored promotions, etc. As such, the product database may be queried by the processing device 114 and may transmit point information to the processing device to facilitate assigning points to a customer who selects a product for purchase in the course of a competition.

The processing device 114 may execute the customer pairing module 120. The customer pairing module may provide information such as a code to customers to allow the customers to pair mobile electronic devices 68 together. The customer pairing module may also receive information from the customers such as customer identification or codes to allow these customers to pair mobile electronic devices 68 together. The customer pairing module 120 may associate mobile electronic devices 68 together to facilitate communications between these mobile electronic devices.

The shopping cart module 122 may receive item information from customers and may create an electronic shopping cart from this information as discussed herein. The shopping cart module 122 may receive item information from a single customer and may create an electronic shopping cart for storage or display on the customer's mobile electronic device 68. The shopping cart module 122 may receive item information from multiple customers and may provide updated electronic shopping cart information to multiple paired customers. The shopping cart module may receive additional information from the product database 130 and may provide this information to a customer as part of or in association with the electronic shopping cart information.

The competition module 124 may facilitate the participation in a competition by a customer. The competition module 124 may receive information regarding an item which is selected and added to a customer's electronic shopping cart. The competition module 124 may assign a point value to that item and may determine a point total which the customer has achieved. The competition module may prepare information regarding the competition such as the points earned by those customers participating in a competition and the relative position of a customer in the competition. The competition module 124 may provide this information to a customer.

The checkout module 126 may facilitate transferring electronic shopping cart information from a mobile electronic device 68 and a POS terminal 10 and may facilitate pairing between a mobile electronic device 68 and a POS terminal 10. The checkout module 126 may receive information from the customer, such as receiving a code from a mobile electronic device 68 identifying a POS terminal 10. The register pairing module 124 may transmit information, such as by transmitting electronic shopping cart information to the POS terminal 10 to facilitate checkout. The checkout module 126 may provide electronic receipts to one or more customers following a completed purchase at the store. The checkout module 126 may receive information from the POS terminal 10, such as receiving information regarding the completed purchase which may include the items actually purchased, the payment method, etc. The checkout module 126 may provide receipt information, such as by providing electronic receipts to one or more customers following a completed purchase.

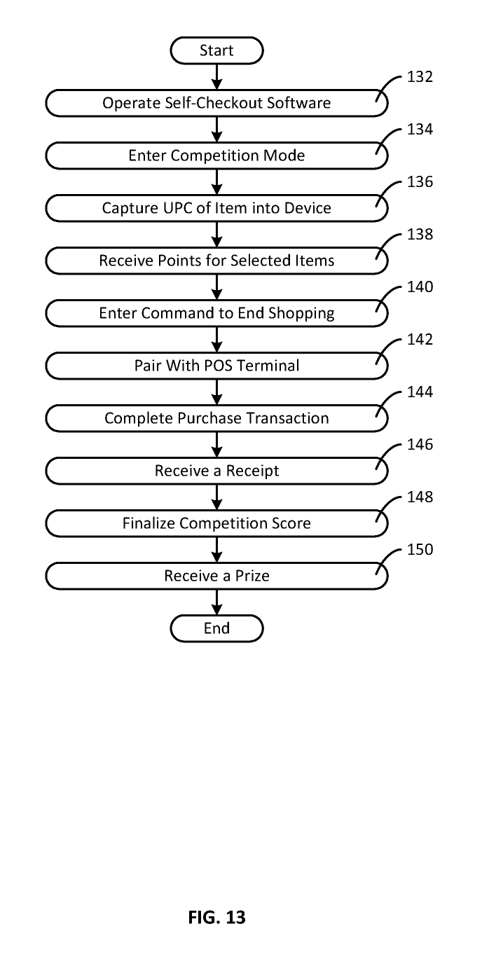

FIG. 13 generally illustrates one or more customers participating in a competition while they are shopping in a brick and mortar store. A customer may first operate mobile self-checkout software 132 on a mobile electronic device 68. In operating self-checkout software, the customer may enter a competition mode 134. The customer may enter a competition and may select among different competition options, such as by selecting a time frame for a competition or by selecting a number of items for purchase. If shopping in a group, the customer may enter a pairing mode wherein the customer pairs their mobile electronic device 68 with the mobile electronic device of one or more other customers. Pairing with other customers may involve transmitting a code or other information between mobile electronic devices and may involve communication with a server 34.

After entering a desired competition, a customer may proceed to select items for purchase and capture codes 136 such as UPC codes on those items into their mobile electronic devices. If desired, the customer may enter price and quantity information for the product into the mobile electronic device using the self-checkout software. The product information may then be added to an electronic shopping cart having information regarding items selected for purchase.

As a customer selects items for purchase, the customer may receive points 138 for the selected items. As discussed, the server 34 may provide points for each selected item based on a variety of item characteristics, performance attributes, sponsorships, promotions, etc. The server may provide the customer with a total amount of points acquired during a competition and may provide a customer with their position in a competition relative to other customer participants in the competition.

When the customer is finished selecting items for purchase, the customer may press a button or otherwise enter a command into their mobile electronic device to end shopping 140. The customer may approach a POS terminal 10 and the electronic shopping cart may be prepared for transfer to the POS terminal for purchase.

When ready, the customer may pair 142 with a POS terminal for checkout. The customer will typically approach a POS terminal 10 with the items that the customer will purchase and with the electronic shopping cart information stored on a mobile electronic device 68. Pairing with a POS terminal 10 may include transmitting data between the POS terminal and the mobile electronic device such as the device 68 capturing a machine readable code at the POS terminal which identifies the particular POS terminal. Pairing the mobile electronic device 68 with a POS terminal 10 may also include transmitting data between the mobile electronic device and a server 34, such as transmitting information received from the POS terminal 10 to the server 34 to indicate with which particular POS terminal the customer is pairing the mobile electronic device. Upon pairing, the server 34 may transmit electronic shopping cart information to the POS terminal 10.

After the mobile electronic device 68 has been paired with the POS terminal 10 and the electronic shopping cart information has been transmitted to the POS terminal, any necessary adjustments may be made to the list of items for purchase. Any additional items which a customer desires to purchase but has not already added to the electronic shopping cart may be scanned at the POS terminal. Any items which the customer does not desire to purchase may be removed from the list of items on the POS terminal as necessary. The customer may then typically complete the purchase transaction 144 and receive a receipt 146.

Completing the purchase transaction may serve to finalize the customer's performance in the competition. The customer competition score may be finalized 148. In some competitions, a customer may be competing with friends of family members and these members may all finish shopping at nearly the same time. Their competition may thus conclude. In some competitions a customer may be competing against other unknown customers and a designated time period may expire before all customers are finished with the competition. Thus, a customer's performance in the competition may be finalized while the overall competition is not yet concluded. When the competition is concluded, a customer may be awarded a prize 150 according to their performance in the competition. The prize may consist of a non-monetary prize such as posting their name on a competition results board or may consist of a treat, snack, coupon, discount, etc.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A computer implemented method comprising:
electronically joining a first mobile electronic device into a shopping competition, the shopping competition being among customers at a brick and mortar store;
receiving a UPC code from a first physical item at the brick and mortar store into the first mobile electronic device;
creating an electronic shopping cart which includes the first physical item on the first mobile electronic device;
assigning a point value to the first mobile electronic device for selecting the first physical item for purchase; and
selecting a winner among competition participants based on points earned by the competition participants in selecting items for purchase.

2. The method of claim 1, wherein the step of electronically joining a first mobile electronic device into a shopping competition includes receiving into the first mobile electronic device a selection of a time period for completing a shopping trip.

3. The method of claim 1, wherein the step of electronically joining a first mobile electronic device into a shopping competition includes receiving into the first mobile electronic device a selection of a number of items for purchase during a shopping trip.

4. The method of claim 1, wherein the shopping competition is among customers who are unknown to each other.

5. The method of claim 1, wherein the step of electronically joining a first mobile electronic device into a shopping competition further includes electronically joining a second mobile electronic device into the shopping competition; and
wherein the method further comprises receiving a UPC code from a second physical item at the brick and mortar store into the second mobile electronic device.

6. The method of claim 5, wherein the step of creating an electronic shopping cart which includes the first physical item on the first mobile electronic device more specifically comprises creating a common electronic shopping cart which includes the first physical item and the second physical item and displaying the electronic shopping cart on the first mobile electronic device and the second mobile electronic device.

7. The method of claim 6, wherein the method further comprises assigning point values to the first mobile electronic device and assigning point values to the second mobile electronic device as a respective first customer and a respective second customer compete to acquire items from a single shopping list.

8. The method of claim 7, further comprising receiving, from a customer, selected point values for items on the shopping list.

9. The method of claim 1, wherein the method more specifically comprises a server assigning a point value associated with the first physical item based on an attribute of the first physical item selected from the group consisting of the price, weight, bulkiness, difficulty to find, item location in a store, brand, color, and item sponsorship.

10. The method of claim 1, wherein the method more specifically comprises a server assigning a point value associated with the first physical item based on time to acquire the item.

11. The method of claim 1, wherein the method further comprises providing a prize to a competition winner.

12. The method of claim 11, wherein the prize is selected from the group consisting of a coupon, a mobile gift card, a discount, and public recognition.

13. A computer system comprising:
a shopping cart module programmed to:
receive a UPC code from a first physical item at a brick and mortar store into a first mobile electronic device; and
create an electronic shopping cart which includes the first physical item on the first mobile electronic device; and
a competition module programmed to:
electronically join the first mobile electronic device into a shopping competition, the shopping competition being among customers at the brick and mortar store;
assign a point value to the first mobile electronic device for selecting the first physical item for purchase; and
select a winner among competition participants based on points earned by the competition participants in selecting items for purchase.

14. The system of claim 13, wherein the competition module is programmed to receive a selection of a time period for completing a shopping trip from the first mobile electronic device to thereby select a competition.

15. The system of claim 13, wherein the competition module is programmed to receive a selection of a number of items for purchase during a shopping trip from the first mobile electronic device to thereby select a competition.

16. The system of claim 13, wherein the competition module is programmed to electronically join a second mobile electronic device into the shopping competition; and
wherein the shopping cart module is programmed to:
receiving a UPC code from a second physical item at the brick and mortar store into the second mobile electronic device; and
create a common electronic shopping cart which includes the first physical item and the second physical item and display the electronic shopping cart on the first mobile electronic device and the second mobile electronic device.

17. The system of claim 16, wherein the competition module is programmed to assign a point value to the first mobile electronic device and assign a point value to the second mobile electronic device as a respective first customer and a respective second customer compete to acquire items from a single shopping list.

18. The system of claim 17, wherein the competition module is programmed to receive, from a customer, selected point values for items on the shopping list.

19. The system of claim 13, wherein the competition module is programmed to assign a point value associated with the first physical item based on the group consisting of the time to acquire the item, item price, item weight, item bulkiness, difficulty to find the item, item location in a store, item brand, item color, and item sponsorship.

20. The system of claim 13, wherein the competition module is programmed to provide a prize to a competition winner.
